(19) United States
(12) Patent Application Publication
(10) Pub. No.: US 2014/0160559 A1
(43) Pub. Date: Jun. 12, 2014

(54) llumination System

(71) Applicants: Michael Mermelstein, Cambridge, MA (US); Charles Cameron Abnet, Waltham, MA (US)

(72) Inventors: Michael Mermelstein, Cambridge, MA (US); Charles Cameron Abnet, Waltham, MA (US)

(21) Appl. No.: 14/098,610

(22) Filed: Dec. 6, 2013

Related U.S. Application Data
(60) Provisional application No. 61/797,413, filed on Dec. 6, 2012.

(51) Int. Cl. G02B 21/06

(52) U.S. Cl. CPC G02B 21/06
USPC 359/385

(57) ABSTRACT

The invention is a system and method for controllable alignment of any of a plurality of electro-optical components mounted to a circuit board with an optical axis. In one embodiment, the invention provides an improved illumination system for microscopy. The system incorporates a circuit board 31 providing structure and directly mounting a plurality of light emitting sources. The mounted light sources are rotatably alignable with a plurality of optical axes. The system further includes selectable conditioning of the sources.

### CROSS-REFERENCE TO RELATED APPLICATIONS

This application claims the benefit of provisional patent application Ser. No. 61/797,413, filed Dec. 6, 2012.

### FEDERALLY SPONSORED RESEARCH

Not applicable

### SEQUENCE LISTING OR PROGRAM

Not applicable

### FIELD OF THE INVENTION

This invention relates to electro-optical systems and particularly to illumination systems for microscopy using a plurality of selectable sources.

### BACKGROUND OF THE INVENTION

Fluorescence microscopy is a fundamental tool in cellular biology. It is used by researchers to monitor cellular function, to investigate gene expression, and to evaluate new drug candidates among an ever-growing collection of applications. In general, fluorescence microscopy uses a bright light source with a predetermined wavelength to excite a fluorophore (chemical label) which then emits light at a wavelength different from the excitation. Typically, as part of an illumination system, excitation colors are conditioned or otherwise collected, shaped, and modified by optical components to provide efficient and even illumination at the image plane of the microscope (i.e. location of the fluorophore). It is well known that an illumination system that has a large number of bright selectable wavelengths is a valuable tool for cellular research.

The prior art includes a number of systems attempting to address this need using a variety of arrangements and excitation sources. Typical prior art systems include filtering a broad-spectrum light source (e.g. white light) to produce a desired excitation color. These systems are typically characterized by a large size, an undesirable amount of waste heat, and expensive, short-lived light sources. Other prior art systems optically mix specific colored sources using dichroic beamsplitters. These systems have been limited to relatively few sources by the complexity and cost of each additional dichroic element. Still other systems have attempted to circumvent the need for complex optics by mechanically switching between a number of specific colored sources. To date, these systems have been characterized by mechanical enclosures and mechanical mountings that significantly limit the number and variety of sources, as well as the speed of mechanical transitions between sources.

It is the purpose of the present invention to provide a novel system that addresses problems of the prior solutions. In addition, the present invention enables lower cost, higher efficiency microscopy and the potential for more rapid, economical cellular research. Further objects and advantages will become apparent from the detailed descriptions that follow.

### SUMMARY OF THE INVENTION

The present invention is a novel electro-optical system providing controllable alignment of any of a plurality of electro-optical components mounted to a circuit board with an optical axis.

Its preferred embodiment provides selectable illumination wavelengths and selectable conditioning optics for microscopy. By exploiting the mechanical, electrical, and thermal properties of a circuit board as well as its efficient manufacture, the present invention provides a high density of wavelength options, low heat generation and low cost.

Using a circular arrangement of surface mounted light sources and directly coupling this arrangement to a controlled motor provides a fast switching, multi-source illumination system. The circular arrangement aligns a light source with a primary optical axis and can be arranged to align a second light source with a secondary optical axis. The low inertia of the circuit board assembly allows the motor to switch rapidly between different sources within the circular arrangement. The high density circular arrangement of light sources provides options for multiply redundant wavelengths, close spatial groupings of application specific wavelengths, and multiple source types including both light emitting diodes and laser diodes.

Electronics manufacturing technologies provide useful arrangements of circuit board features, control circuitry, and light sources. Additional electrical, thermal, and mechanical features can be integrated directly into the circuit board including temperature and light sensing components, clusters of through-holes for thermal management and flexible, cantilevered substrate regions providing a unique combination of structures.

### BRIEF DESCRIPTION OF THE DRAWINGS

FIG. 1 shows a preferred embodiment of an illumination source assembly including a circuit board, multiple surface mounted solid-state sources, electrical signal connection, and thermal management structures.

FIG. 2 shows an additional embodiment of an illumination source assembly with multiple illumination source types and sensors.

FIG. 3 shows a circuit board having both an illumination source and an illumination sensing means arranged to measure light interacting with a target.

FIG. 4 shows an additional embodiment of an illumination source assembly with narrow gaps in the circuit board separating sources.

FIG. 5 shows a preferred embodiment of the illumination source assembly rotatably mounted and with accessory mechanical components.

FIG. 6 shows an exploded view of preferred embodiment of the illumination source assembly rotatably mounted and with accessory mechanical components.

FIG. 7 shows an illumination source assembly including a circuit board having an aperture.

FIG. 8 shows a circuit board with a coherent source and a diffuser mounted in front of the source using a flexible support that lets the diffuser vibrate relative to the source.

FIG. 9 shows an illumination system with a fiber optic cable mounted and aligned with a secondary optical axis.

FIG. 10 shows an illumination source assembly with an axis of rotation that is not parallel to several example orientations of the primary optical axis.

FIG. 11 shows an illumination source assembly with an axis of rotation that is not parallel to the primary optical axis and with a circuit board having a non-circular radial array of electro-optical components.

FIG. 12 shows an additional embodiment of a rotatable substrate integrating conditioning optics.

FIG. 13 shows an additional embodiment of an illumination assembly positioned adjacent to another rotatably selectable assembly having conditioning optics.

### DETAILED DESCRIPTION

The preferred embodiment of the present invention is an illumination system for a microscope. It generally comprises a light source assembly constructed from a circuit board with a geometry and pattern of light emitting components convenient for rotational positioning and alignment with multiple optical axes. An additional embodiment includes a selectable sensor array comprising surface mounted sensors with varying sensitivities to radiation. An arrangement combining the sourcing and the sensing of light provides another embodiment.

### Light Source Assembly

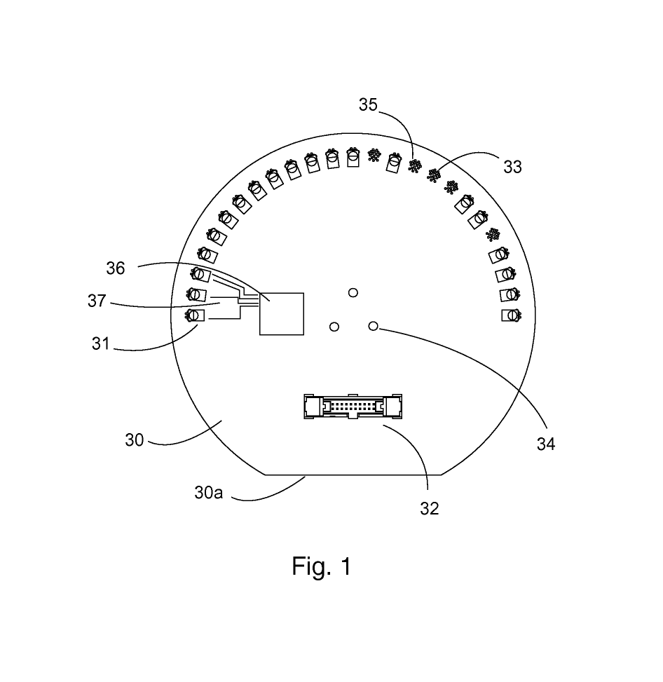

FIG. 1 shows a manufactured circuit board 30 providing multiple mounting locations 33 (i.e. 25 locations in FIG. 1). Each mounting location can be populated with an individual light emitting component 31. In this embodiment, each location is occupied by a light emitting diode (LED). Each LED is a surface mounted device soldered in place to locations or pads provided during manufacture of the circuit board. These pads are well known to the art as are similarly scaled sockets (not shown) or surface mount adapters (not shown) for mounting LEDs. The circuit board 30 is circular with a flat portion 30a used to align the circuit board during subsequent mounting. Mounting holes 34 surround and define the preferred rotational axis of the circuit board. In one embodiment, the LEDs are arranged in circular pattern centered on the rotational axis of the circuit board. In another embodiment, additional LEDs are arranged in concentric circular patterns centered on the rotational axis of the circuit board. In yet another embodiment, LEDs are mounted along radii passing through the rotational axis of the circuit board in a non-circular array.

In addition, each location is characterized with a pattern of holes 35 drilled through the circuit board. These holes are tinned in a manner familiar in circuit board manufacture. In this case, the holes act as a heat sink for each LED component. Each mounted LED component is in thermal contact with a cluster of holes.

A control circuit, schematically shown as a single square region 36, but typically a collection of components, is mounted directly to the circuit board 30 and interfaces with a control computer (not shown). The interface is established via a cable connected using the connector 32. In operation, timing and command signals are directed via the control circuit out to one or more LED components using circuit traces on the circuit board. A portion of the circuit traces are shown as item 37.

### Light Source Arrangement

In the embodiment of FIG. 1, each LED provides a unique spectrum of light. In this case, each LED emits light centered on a wavelength (color) as well as wavelengths of light spanning a narrow band around this color. The preferred embodiment mounts the maximum number of unique LED colors available and hence many high efficiency excitation wavelengths for fluorescence microscopists. Currently, there are approximately 20 unique, high intensity LED colors commercially available. As more colors are marketed by LED manufacturers, each can be added to the circuit board 30 at available locations. In addition, alternative embodiments with higher mounting density, larger diameter mounting arrangements, multiple concentric mounting arrangements on a single circuit board, or an axial stack of circuit boards can increase the mount capacity for light emitting sources.

In typical usage, some colors are more popular with microscopists. For example, users of fluorescent microscopy often allocate a 405 nm wavelength (violet) to mark the nucleus of cells. In this case, violet sources can be placed in multiple locations around the rotary platform. Thus, a sequence of colors including violet can strategically use the nearest violet source and reduce transition times between violet and non-violet sources. Furthermore, multiple instances of a given color provides redundancy and an improvement in mean-time-to-failure. Similarly, multiple wavelengths can be grouped in adjacent mount positions corresponding to popular multi-color (multi-plexed) assays further minimizing the required motion for a specific measurement.

### Additional Mounted Sources and Components

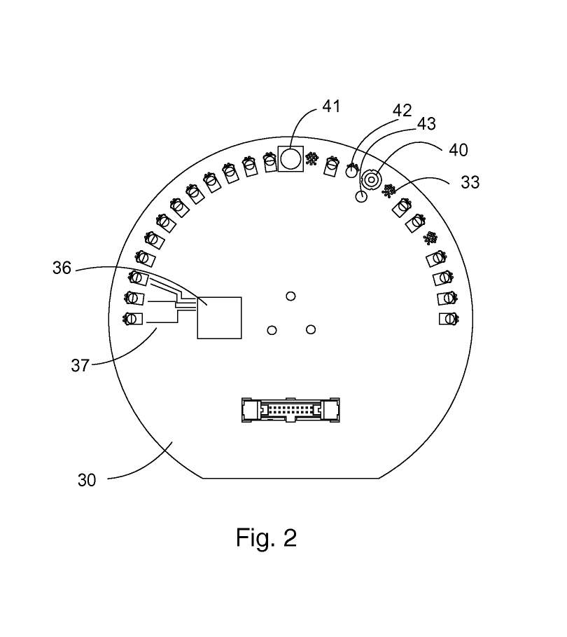

The circuit board construction provides a number of alternative embodiments mixing a high density arrangement of mixed light sources, circuitry, and sensors. FIG. 2 depicts different types of light sources including a large field LED 41 that might incorporate several LED dice in a single chip. In addition, one or more circuit board mountable solid-state laser sources 40 can be mounted directly to the circuit board and controlled with an appropriate version of the circuit 36.

Several sensors are included in this embodiment as items 42 and 43. Sensors can be mounted immediately adjacent to source components and control circuitry providing, cost effective, efficient, and reliable construction. Sensors and sources are directly mounted to the mechanical substrate without need for additional mounting means or additional cabling. For example, a photodiode can be used to detect a portion of the emitted light from a source and provide feedback for the control circuit. Light output intensity feedback allows consistent output intensity control and can be used as a detection means to locate failed or degrading light sources. Similarly, a temperature sensor mounted adjacent to one or more sources can monitor thermal conditions and detect unsafe operating conditions.

### A System Embodiment Including Elements for Measurement of Focus Quality

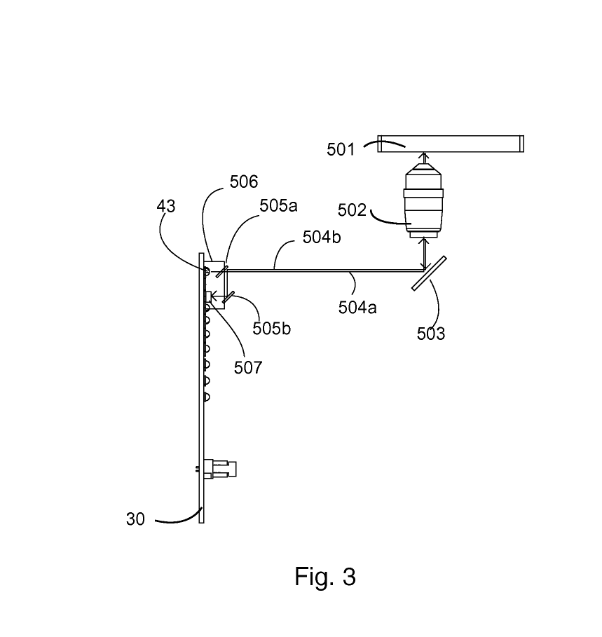

A specific embodiment and application of both active and passive electro-optical components is shown in FIG. 3. A target 501 (e.g. a microtiter plate) is positioned relative to an infinity-corrected objective lens 502. A circuit board 30 is supporting a collimated illumination source (e.g. laser diode) 43, a light sensor 507, and an optical mount which in turn supports beamsplitter 505a and mirror 505b. The circuit board is positioned such that light 504a emitted from 43 passes through beamsplitter 505a is reflected by mirror 503, then passes through lens 502, and then interacts with target 501. A portion of light 504b returning from the target is directed by beamsplitter 505a and mirror 505b to the sensor 507. In operation, the sensed light 504b can be used as an indicator of the quality of focus between lens 502 and a suitable surface of target 501.

Additional Circuit Board Features

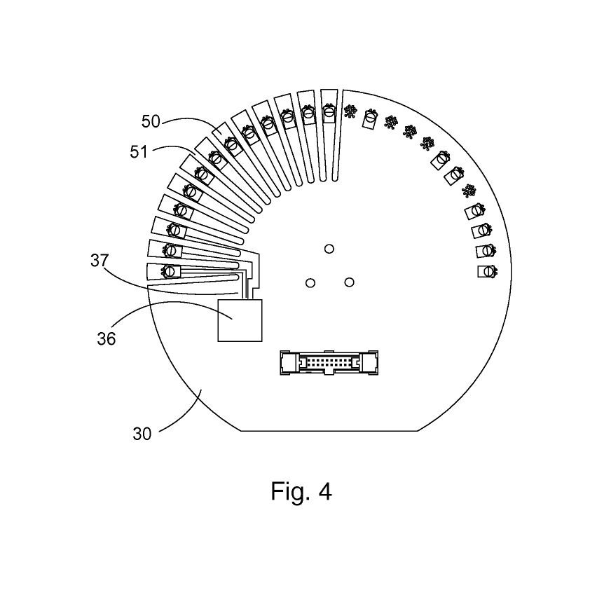

The mechanical, electrical, and thermal role played by the circuit board 30 enables further novel features demonstrated in the embodiment of FIG. 4. A portion of the substrate is manufactured to form fingers 50 separated by gaps 51. In this case, there are 13 individual fingers. The fingers provide at least two additional benefits to the assembly in operation. First, the fingers thermally isolate neighboring LED components. In this way, over-heating of one component does not extend efficiently to adjacent components. Second, the fingers mechanically isolate neighboring LED components. Essentially, each component is mounted near the end of a cantilevered portion of the circuit board. This adds a mechanical flexibility to the position of each component and by adding a linear actuator such as a small solenoid, it allows individual adjustment of each light source's position along the optical axis of the component. Thus, each component can be focused optimally.

### Mounted Light Source Assembly

The circuit board is often constructed of a multi-layer fiberglass composite or ceramic and is both lightweight and strong; ideal for high speed rotary positioning applications.

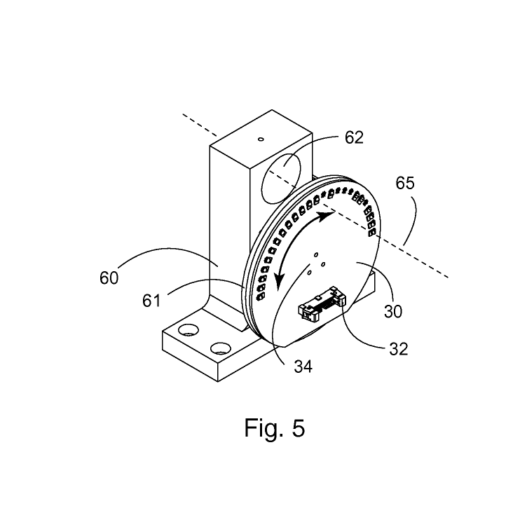

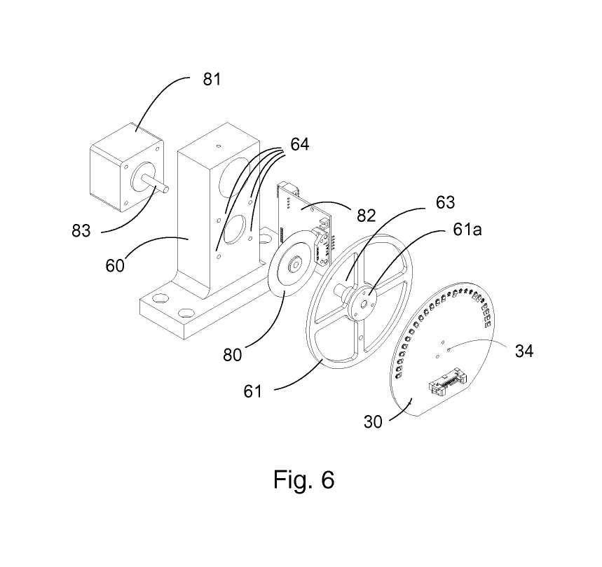

The preferred embodiment additionally mounts the light source assembly as shown in FIG. 5 and in an exploded view in FIG. 6 to a rotatable mount. The substrate 30 is mounted with screws inserted through holes 34 into a mechanical backing disk 61 and corresponding holes 61a. The backing disk is further mounted to the shaft 83 of stepper motor 81 using shaft mount 63. The backing disk couples motion from the motor to the circuit board but also acts as an additional thermal heat sink for the LED components when thermally connected to the circuit board. The motor is mounted and supported by a motor stand 60 using mounting positions 64. A rotary optical encoder 80 and motor controller 82 are mounted to the motor shaft 83 and motor stand respectively. A location for mounting an auxiliary light source is shown as bore hole 62.

In operation, power and position control signals are directed through controller 82 to the stepper motor 81 and produce controlled rotation of the motor's shaft. Consequently, the backing disk, and the substrate attached to it, rotate an identical angular displacement. The controlled rotation positions a predetermined LED component in line with the primary optical axis 65 or a secondary axis. At substantially the same time, the optical encoder position is measured to confirm the angular position of the circuit board. After positioning, illumination commands (for example, current amplitude and current duration) are sent to aligned LED components.

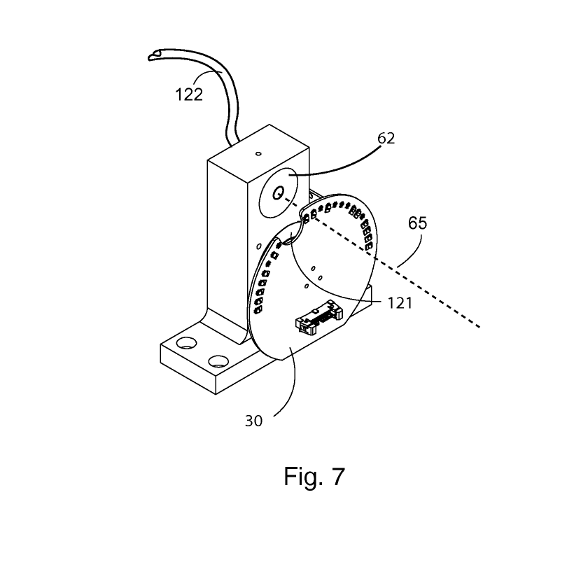

In an additional embodiment shown in FIG. 7, the light source assembly further includes an aperture, cut-out, or through hole 121 integral to the circuit board 30. In operation, the light source assembly can be rotated to align the aperture 121 with an auxiliary source mount 62 and primary optical axis 65. In this case, an auxiliary light source is provided via an optical fiber 122. This position of the aperture allows an auxiliary light source to provide light along the primary axis. This feature extends the usefulness of the present invention by allowing larger external laser sources or legacy arc lamps to be incorporated into the present illumination system if needed.

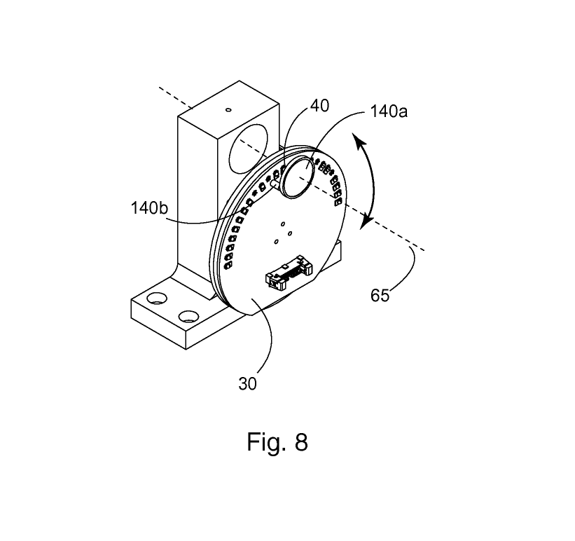

It is known that laser illumination as a light source in microscopy is generally characterized by speckle in the image caused by structures in the sample that scatter the incident light which then produces a light and dark pattern of interference. This effect introduces spurious contrast and confounds image analysis. A diffusing component can be arranged to interact with a laser source 40 on a single circuit board assembly as shown in FIG. 8. In this case, a diffuser 140a is compliantly mounted (e.g. by flexible post 140b) to circuit board 30 in a position such that suitable rotation of the circuit board will produce a resonant or chaotic motion of the diffuser and subsequently produce variations of the speckle pattern on a time scale shorter than the exposure time of the measurement. In this way, a number of varying speckle patterns are integrated to produce an improved measurement.

A Light Source Assembly with Multiple Axes and Light Conditioning

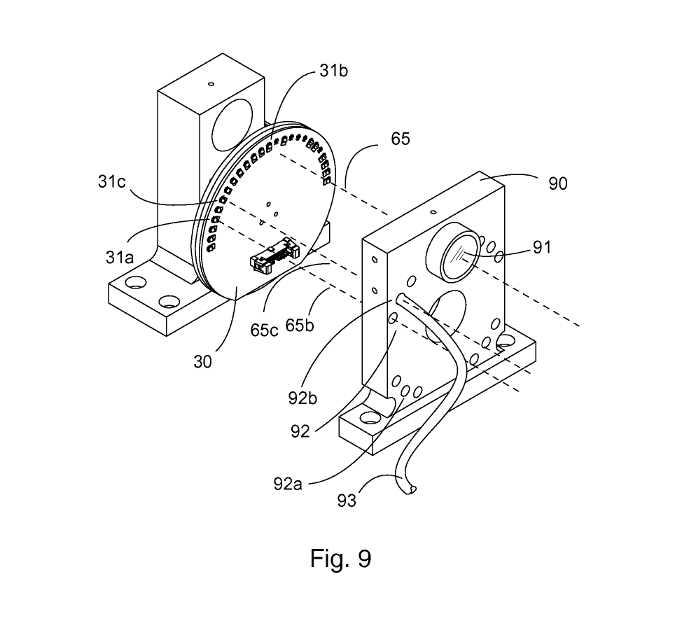

FIG. 9 shows an enlarged view of the light source assembly and a static optical stand 90. Collection optics 91 are shown aligned with the primary axis 65 while several additional mounting locations 92, 92a, and 92b are shown. In this case, these locations are mounts for fiber optic cables, an example is shown as 93. The additional mounting locations are positioned to align with known LED components along secondary optical axes parallel to the primary optical axis and represented by examples 65b and 65c. In this way, light from a plurality of LED components can be collected along a plurality of optical axes. More specifically, the fiber optic 93 can be positioned to provide illumination for a sequence of conditioning optics used as a transmission brightfield light source while the LED component 31b provides illumination along an optical axis for epi-fluorescence.

In operation, a selected LED component 31b is positioned along the primary optical axis 65 by controlled rotation of mounted circuit board 30. A command signal (not shown) turns on LED 31b. The collection lens 91 (a conditioning optic) efficiently directs emitted light along the primary axis 65. All mounted LEDs can be aligned with at least one secondary axis. The mechanical spacing of mounts 92 and 92b allow alignment of axes simultaneously with several LEDs. For example, mount position 92b aligns with LED 31c and in this case mounted fiber 93. A command signal (not shown) turns on LED 31c independently of other LEDs.

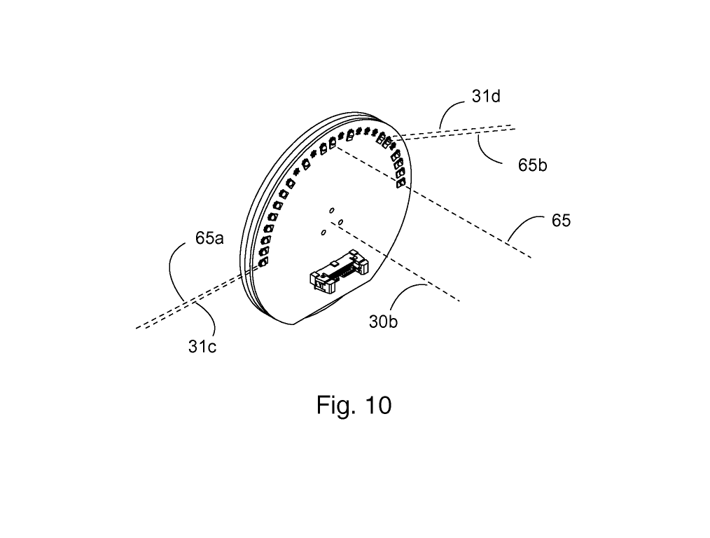

An additional embodiment is shown in FIG. 10 in which several possible orientations of the primary optical axis 65 are shown as axes 65a and 65b and are not parallel to the axis of rotation 30b of the circuit board (rotatable mounting of the circuit is not shown). In these cases, the output direction of LED components (e.g. 31c and 31d) are suitably oriented to align with the primary axis when each component is rotated into position.

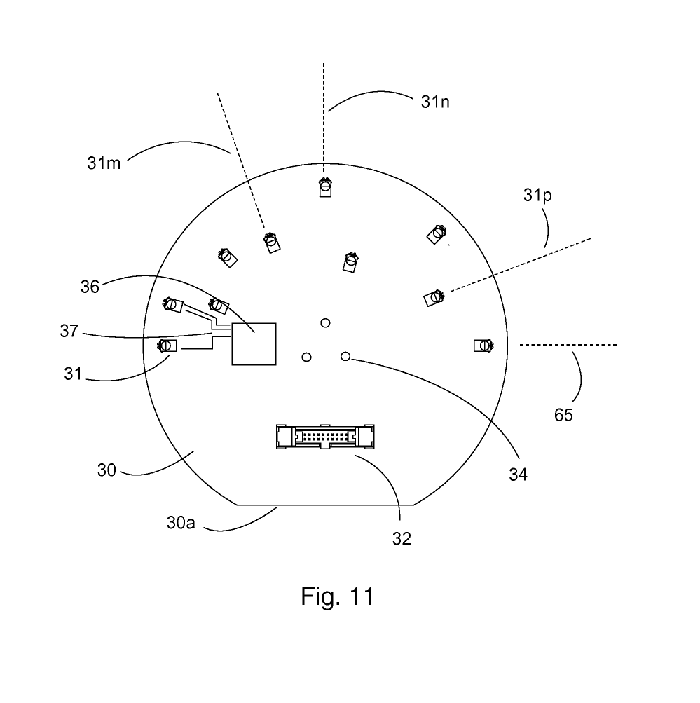

Similarly, FIG. 11 shows an embodiment where eletro-optical components (e.g. LEDs) are arranged in a non-circular radial array. This arrangement has the benefit of increasing the spacing between components providing room for irregular shapes and reducing the thermal interaction among neighbors. In this configuration, the circuit board is rotated around an axis orthogonal to primary optical axis 65 selectively aligning the output axis of components (e.g. 31m, 31n, 31p) with axis 65.

Many other orientations of the rotatably mounted circuit board that still allow alignment of a collection of arranged optical components are within the scope of the present invention.

### A Series of Rotatably Mounted Circuit Boards

The Present Invention Can Stack Boards to Increase mounting area, bring additional heat sinking, peltier cooling, or opto-mechanical options into proximity with a primary platform. These stacked boards can operate similar to daughter boards familiar to the art of printed circuit board assemblies. In addition, several independently rotatable circuit board assemblies can be placed adjacent to one another and provide additional capabilities as a combined system.

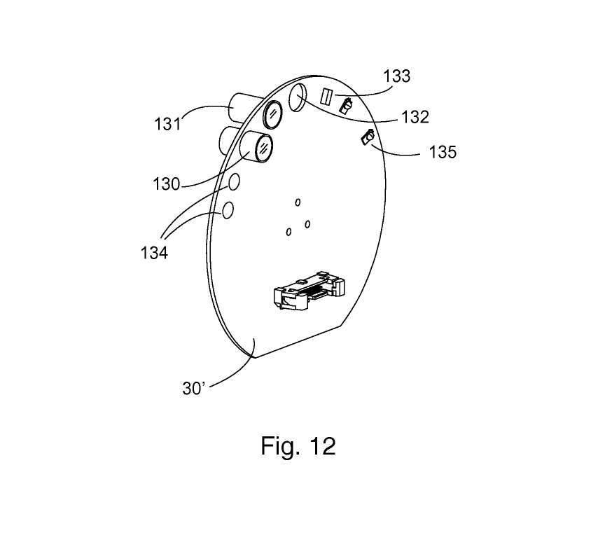

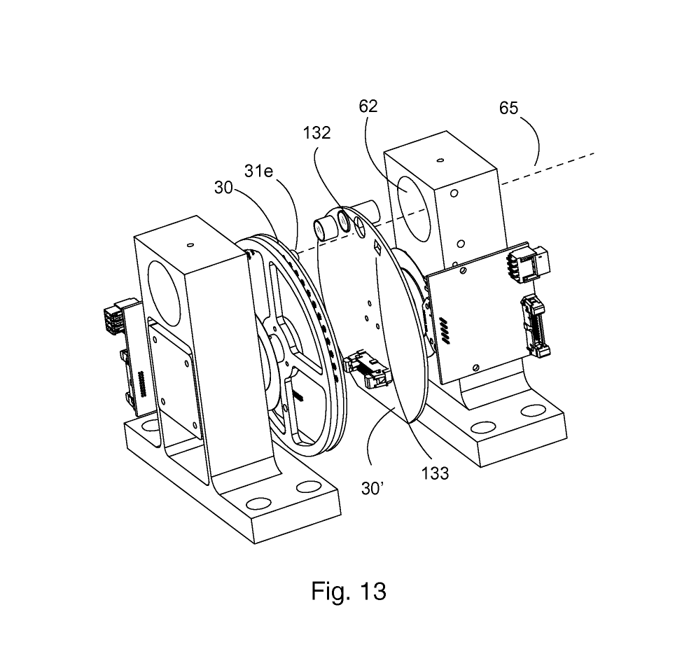

An additional embodiment of a circuit board assembly is shown in FIG. 12. In this case, the circuit board 30′ is decorated with mounted optics 130 and 131, optical sensors 134, clear apertures 132 and 133, as well as LED component 135. Components can be integrated on both sides of the circuit board. Possible mounted optics include lenses, polarizers, filters, masks, and additional solid-state-laser housings. In FIG. 13, a circuit board assembly as shown in FIG. 12 is independently mounted to a rotatably controllable stepper motor with position encoding in a manner similar to the illumination source assembly and positioned adjacent to another mounted assembly.

In operation, the circuit board 30′ is rotated to align a selected optical component with a selected LED source of circuit board 30. Thus, components of 30′ provide selectable conditioning to light sources mounted to 30. For example, an LED component 31e on circuit board 30 is aligned to the primary optical axis 65. In addition, a lens mounted to circuit board 30′ is aligned to the primary optical axis and provides predetermined conditioning to light emitted from 31 e. The conditioned light passes through the aperture 62. In another example, clear aperture 133, shown as a rectangle, is intended to act as an illumination mask. Several methods can be used to construct the rectangular mask including machining directly through the circuit board substrate, laminating a thin foil with a patterned mask (aperture) onto the circuit board, mounting a photolithographically patterned target onto the circuit board (e.g. chrome on glass).

In operation, this mask can be projected onto the focal plane of the microscope. The resulting projected pattern of light is a rectangle constructed to match the light sensitive area of a CCD camera. In this way, light illuminates only intended regions of the target that are viewed by the camera. This is advantageous when using fluorescent targets whose fluorophore can have a reduced useful lifetime when subjected to unintended light. Additional projected patterns for various structured illumination techniques can be added to circuit board 30′ such as a fine array of stripes, a grid of lines, or an array of pin holes.

In another example, a low angle diffusing component mounted on circuit board 30′ is arranged as a conditioning optic for a mounted laser diode 40 on circuit board 30. In operation, the position of the diffuser, perpendicular to the optical axis, is varied by controlled rotations of the circuit board 30′ to impart changes to the laser speckle and improve measurements.

The circuit board 30′ can provide a high density of illumination masks and conditioning components directly adjacent to control electronics and sensors. The sequence of two circuit board assemblies shown in FIG. 13 can be extended to more circuit boards in series if needed.

Additional alternative designs and assemblies are within the scope of this disclosure and although several are described they are not intended to define the scope of the invention or to be otherwise limiting.

We claim:

1. An electro-optical system comprising:
an optical axis,
a circuit board supporting a plurality of electro-optical components arranged in an angular array, and
controllably rotatable mounting means supporting said circuit board
wherein said mounting means positions said circuit board to align a first electro-optical component with the optical axis in a first rotational position and to align a second electro-optical component with the optical axis in a second rotational position.

2. The system of claim 1 wherein said optical axis comprises an illumination axis of an optical microscope.

3. The system of claim 1 wherein said angular array comprises a circular array.

4. The system of claim 1 wherein said electro-optical components are chosen from the list including light source, light emitting diode, laser source, radiation sensor, light detector, photodiode, photovoltaic cell, bolometer, image sensor, area sensor, line sensor, light modulator, galvo-mirror, liquid crystal device.

5. The system of claim 1 wherein said electro-optical components comprise at least one light source and further comprising a light sensing component additionally supported on said circuit board and positioned to sense at least a portion of light emitted by said light source.

6. The system of claim 5 further comprising a specimen positioned to interact with light from said light source wherein sensing said portion of light comprises a measurement of said interaction.

7. The system of claim 1 wherein said angular array further comprises passive optical components.

8. The system of claim 7 wherein said passive optical components are chosen from the list including aperture, mask, grid, mirror, lens, window, filter, beamsplitter, beam combiner, grating, prism, wedge, diffractive optical element, diffuser.

9. The system of claim 1 wherein said plurality of electro-optical components comprises a plurality of light emitting components wherein a first one of said light emitting components emits light of a first spectrum and a second one of said light emitting components emits light of a second spectrum.

10. The system of claim 9 wherein said first spectrum and said second spectrum are substantially equal.

11. The system of claim 1 further comprising a second optical axis wherein said mounting means positions said circuit board to align at least one said electro-optical component with said second optical axis in at least one rotational position.

12. The system of claim 1 further comprising a thermal structure in thermal communication with at least one of said electro-optical components.

13. The system of claim 12 wherein said thermal structure is taken from the list including circuit board through-hole array, circuit board routing geometry, circuit board metal plane, heat sink, cantilevered finger, mechanical backing disk.

14. A method for constructing an electro-optical system including the steps of:
providing at least one optical axis
providing at least one circuit board supporting a plurality of electro-optical components arranged in an angular array,
mounting the at least one circuit board to a controllably rotatable mounting means
rotating said at least one circuit board using said controllably rotatable mounting means so as to align a first one of said electro-optical components with said at least one optical axis
rotating said at least one circuit board using said controllably rotatable mounting means so as to align a second one of said electro-optical components with said at least one optical axis

15. The method of claim 14 wherein said optical axis comprises the illumination axis of an optical microscope.

16. The method of claim 14 wherein said angular array comprises a circular array.

17. The method of claim 14 wherein said electro-optical components are chosen from the list including light source, light emitting diode, laser source, radiation sensor, light detector, photodiode, photovoltaic cell, bolometer, image sensor, area sensor, line sensor, light modulator, galvo-mirror, liquid crystal device.

18. The method of claim 14 wherein said plurality of electro-optical components comprises a plurality of light emitting components wherein a first one of said light emitting components emits light of a first spectrum and a second one of said light emitting components emits light of a second spectrum.

19. A method for illuminating a scene comprising the steps of:
providing a circuit board supporting a coherent light source
providing an illumination path from said coherent light source to said scene
mounting a diffuser to said circuit board
optically coupling said diffuser to said coherent light source
mounting said circuit board to a motorized mount
moving said diffuser using said motorized mount to mitigate laser speckle artifacts observed in said scene

20. The method of claim 19 wherein said step of moving said diffuser using said motorized mount comprises exciting a motion of said diffuser relative to said circuit board that persists for a period following said excitation.
